(19) United States
(12) Patent Application Publication
(10) Pub. No.: US 2014/0380090 A1
(43) Pub. Date: Dec. 25, 2014

(54) STORAGE CONTROL DEVICE AND STORAGE CONTROL METHOD

(71) Applicant: FUJITSU LIMITED, Kawasaki-shi (JP)

(72) Inventors: Kenji Kobayashi, Kawasaki (JP); Norihide Kubota, Kawasaki (JP); Ryota Tsukahara, Kawasaki (JP); Hidejirou Daikokuya, Kawasaki (JP); Kazuhiko Ikeuchi, Kawasaki (JP); Chikashi Maeda, Kawasaki (JP); Takeshi Watanabe, Kawasaki (JP)

(73) Assignee: FUJITSU LIMITED, Kawasaki-shi (JP)

(21) Appl. No.: 14/273,891

(22) Filed: May 9, 2014

(30) Foreign Application Priority Data
Jun. 24, 2013 (JP) 2013-131592

(51) Int. Cl. G06F 11/07

(52) U.S. Cl. CPC G06F 11/073
USPC 714/6.12

(57) ABSTRACT

A storage control device includes a processor. The processor is configured to detect medium error regions in a first memory device. A medium error has occurred in each of the medium error regions. The processor is configured to conduct, on a first medium error region, data recovery processing for recovering data stored therein. The processor is configured to conduct copy processing for copying first data of a peripheral region of the first medium error region from the first memory device to a second memory device other than the first memory device.

### CROSS-REFERENCE TO RELATED APPLICATION

This application is based upon and claims the benefit of priority of the prior Japanese Patent Application No. 2013-131592, filed on Jun. 24, 2013, the entire contents of which are incorporated herein by reference.

### FIELD

The embodiment discussed herein is related to a storage control device and a storage control method.

### BACKGROUND

A storage device is configured, for example, with disk array devices. A technology such as a redundant array of independent (or inexpensive) disks (RAID) for controlling a plurality of disks (memory devices: hard disk drives (HDDs) or the like), for example, in combination as one disk (RAID group) may be used as a disk array device. The loss of data stored on the disks may be reduced through the use of the RAID technology. Data placement in each disk and redundancy of data differ in accordance with a level (e.g., RAID1 to RAID6) of RAID in the RAID technology.

A RAID device signifies herein a disk array device that uses the RAID technology. Control units in a RAID device are often made redundant for data assurance in a RAID device. In the following description, a control unit in a RAID device may also be referred to as a “RAID device” or as a “storage control device”.

An information storage medium such as a magneto-optical disk or an optical disk may incur physical defects during manufacturing or during use after manufacturing. For example, dust or dirt may adhere to the surface of a disk or the surface of the disk may become scratched. A medium error occurs when conducting a read access (disk read) in a region (data block) in which such a defect is present because the data is not read properly from the region.

While a data recovery that includes a medium recovery is conducted when a medium error occurs, the target of the data recovery is normally only the data block in which the medium error has been detected. The data block corresponds to, for example, a region (sector) segmented into units of a specific size on a disk. Herein, data recovery processing during normal operation of a RAID group will be described with reference to the flow chart (A1 to A6) illustrated in FIG. 7.

During normal operation of a RAID group (A1), a disk read is conducted (A2) and a response from the disk regarding the disk read is checked (A3). If the response from the disk is normal, that is if the data is read properly from the disk (A3: “Normal”), the normal operation of the RAID group is continued (A4).

If the response from the disk is not normal, that is if the data is not read properly from the disk and a medium error occurs (A3: “Error”), data recovery processing is conducted (A5). During the data recovery processing, the data stored in the medium error region (unit region) in which the medium error has occurred is regenerated using data stored in a disk other than the disk having the medium error region. The regenerated data is saved to a region (substitute region) without a defect in the disk having the medium error region. The region without a defect is logically associated with the medium error region. After the data recovery processing has been conducted in this way, the normal operation of the RAID group is continued (A6).

Related techniques are disclosed in, for example, Japanese Laid-open Patent Publication No. 7-176142 and Japanese Laid-open Patent Publication No. 2005-157739.

Recently, while the physical size of scratches and dirt and the like that cause medium errors does not change, storage unit regions in information storage media have become smaller with increases in the capacity of disks. As a result, there is a tendency for more frequent medium errors in peripheral regions of the medium error region (data block) in which the medium error is detected, that is in adjacent regions that are physically connected to the medium error region.

Therefore, when a medium error occurs in a data block, another medium error may also occur in a peripheral region of the data block at the same time or at substantially the same time. Or the medium of the peripheral region may be normal at the above time and a medium error may occur in the peripheral region at a later time. In either case, it is highly likely that a data loss will occur during a rebuild operation as described later since the medium error in the peripheral region is not detected without an actual access to the peripheral region.

A rebuild is processing for automatically recovering redundancy in a RAID group and involves the use of data stored in a disk other than the failed disk in the same RAID group to reconstruct the data of the failed disk in a hot spare (HS) when a disk that belongs to the RAID group fails. The HS is a substitute disk to be used in a process such as a rebuild and waits in preparation for a disk failure. A disk is determined to have failed when, for example, a medium error has occurred a certain number of times.

When an input/output (I/O) request to a medium is received from a host, the region to be accessed once due to the I/O request is relatively small (i.e., the number of data blocks is relatively few). As a result, during an access due to an I/O request, while consecutive errors (medium errors in a peripheral region) are not easily detected, redundancy of the data is maintained with a high probability in the access region. Therefore, it is highly probable that the data in the region in which the medium error is detected will be restored.

In contrast, during rebuild processing, while data of regions of a certain size are sequentially read from a disk (rebuild origin), in a RAID group, other than the failed disk to an HS (rebuild destination), the certain size is larger than the size of the region accessed once by an I/O request. As a result, during a rebuild operation, while consecutive errors (medium errors in a peripheral region) are easily detected, it is unlikely that the redundancy of the data in the region of the certain size will be maintained. Therefore, there is a problem that data in a region in which a medium error is detected is unlikely to be restored, that is there is a high probability that data loss will occur, and thus the data in a peripheral region of a medium error region is not assured.

Herein, rebuild processing during a non-redundancy state of a RAID group will be described with reference to a flow chart (B1 to B6) illustrated in FIG. 8.

When rebuild processing is started (B1, B2), a disk read of the rebuild origin is conducted and data stored in a region of a certain size is read sequentially from the rebuild origin to the HS (rebuild destination) (B3). Each time that a disk read is conducted, the response from the rebuild origin subject to the disk read is checked (B4).

If the response from the rebuild origin is normal, that is if data stored in a region of the certain size is read properly from the rebuild origin (B4: “normal”), the rebuild processing is continued (B5).

If the response from the rebuild origin is not normal, that is if the data stored in the region of the certain size is not read properly from the rebuild origin (B4: “abnormal”), a data loss occurs (B6). Due to the non-redundancy state, the data stored in the region is not reconstructed in the rebuild destination.

### SUMMARY

According to an aspect of the present invention, provided is a storage control device including a processor. The processor configured to detect medium error regions in a first memory device. A medium error has occurred in each of the medium error regions. The processor configured to conduct, on a first medium error region, data recovery processing for recovering data stored therein. The processor configured to conduct copy processing for copying first data of a peripheral region of the first medium error region from the first memory device to a second memory device other than the first memory device.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a storage system and a functional configuration of a storage control device of the present embodiment;

FIG. 2 is a view for explaining a definition of a peripheral region according to the present embodiment;

FIG. 3 is a view for explaining a method for using a dedicated region and for explaining registered contents in a copy management table according to the present embodiment;

FIG. 4 is a flow chart of recovery processing by a recovery control unit and of copy processing by a copy control unit according to the present embodiment;

FIG. 5 is a flow chart of processing for determining a copy destination disk by the copy control unit according to the present embodiment;

FIG. 6 is a flow chart of rebuild processing by a rebuild control unit according to the present embodiment;

FIG. 7 is a flow chart for explaining data recovery processing during normal operation of a RAID group; and

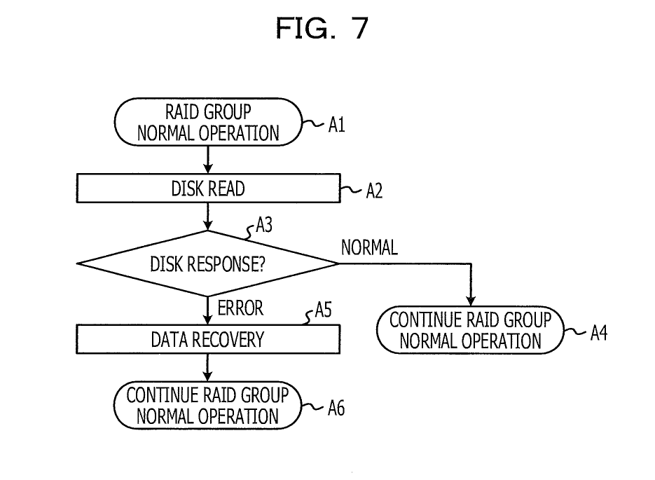

FIG. 8 is a flow chart for explaining rebuild processing during a non-redundancy state of a RAID group.

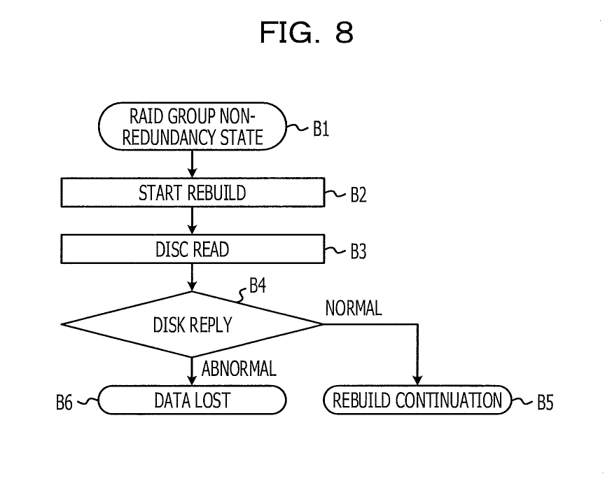

### DESCRIPTION OF EMBODIMENTS

In the following description, an embodiment will be described in detail with reference to the drawings.

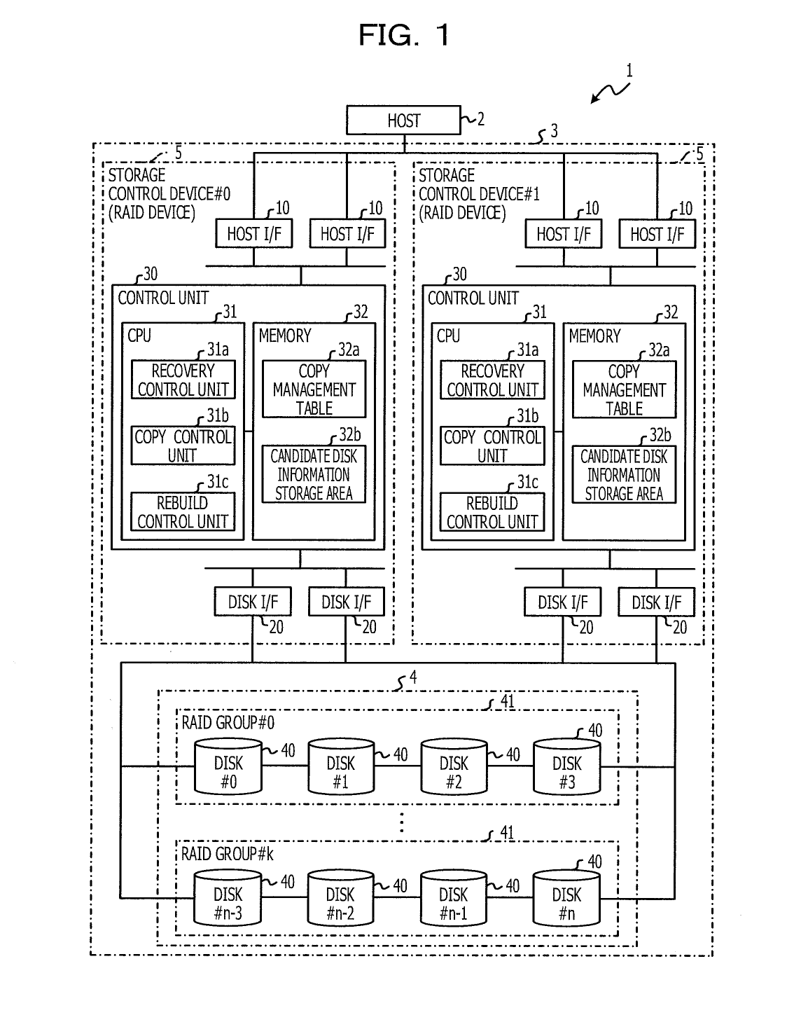

A configuration of a storage system 1 and a functional configuration of a storage control device 5 according to the present embodiment will be described with reference to FIG. 1. FIG. 1 is a block diagram illustrating a configuration of the storage system 1 and a functional configuration of the storage control device 5 of the present embodiment.

As illustrated in FIG. 1, the storage system 1 of the present embodiment includes a host device (a host computer, hereinafter referred to simply as “host”) 2 and a storage device 3. The host 2 sends I/O requests, such as read/write accesses, to a medium (below-mentioned disk 40) in the storage device 3. The storage device 3 is configured, for example, by a disk array device and includes a disk unit 4 and a plurality (two in FIG. 1) of storage control devices 5.

The disk unit 4 includes a plurality (n+1 in FIG. 1) of disks 40. The disks 40 (memory devices) are hard disk drives, for example, and store therein user data to be accessed by the host 2 and various types of control information and the like. The storage device 3 of the present embodiment uses a RAID technology for controlling a combination of a plurality (four in FIG. 1) of disks 40 as one virtual disk (RAID group) 41. In the disk unit 4 illustrated in FIG. 1, k+1 RAID groups 41 are configured by n+1 disks 40.

Here, n and k are natural numbers and n=4k+3. In FIG. 1, four disks disk#0 to disk#3 are included in RAID group#0 and four disks disk#n−3 to disk#n are included in RAID group#k. In the following description, a specific disk 40 is referred to as one of disk#0 to disk#n. Similarly, a specific RAID group 41 is referred to as one of RAID group#0 to RAID group#k. Although not illustrated in FIG. 1, the disk unit 4 includes a disk 40 (HS) that is used as a below-mentioned rebuild destination disk (substitute memory device). Although the disk 40 is used as a memory device in the present embodiment, a memory device (medium) such as a solid state device (SSD) may be used in place of the disk 40.

In the present embodiment, two storage control devices 5 are redundantly provided (duplicated) for data assurance. The two storage control devices 5 have the same or substantially the same configuration. In the following description, a specific storage control device 5 is referred to as one of storage control device#0 and storage control device#1.

The storage control devices 5 each have a host interface (I/F) 10, a disk I/F 20, and a control unit 30.

The host I/F 10 functions as an interface between the host 2 and the control unit 30. In the present embodiment, two host I/Fs 10 are redundantly provided (duplicated). The disk I/F 20 functions as an interface between the disk unit 4 (disks 40) and the control unit 30. In the present embodiment, two disk I/Fs 20 are redundantly provided (duplicated).

The control unit 30 controls the disk unit 4 (disks 40, RAID groups 41) in accordance with I/O requests and the like received from the host 2. The control unit 30 includes a central processing unit (CPU) 31 and a memory 32. Although not illustrated in FIG. 1, a graphical user interface (GUI) may be provided for a user to input various instructions and various types of information to the CPU 31. The GUI may include an input apparatus such as a mouse and a keyboard and an output apparatus such as a liquid crystal display (LCD).

The CPU 31 performs processing and conducts various types of controls according to an operating system (OS), and fulfills functions as a recovery control unit 31a, a copy control unit 31b, and a rebuild control unit 31c, as described below, by executing a storage control program saved in the memory 32. The memory 32 stores therein various types of information including the above-mentioned storage control program and a below-mentioned copy management table 32a. The memory 32 also has a below-mentioned candidate disk information storage area 32b. The memory 32 is, for example, a random access memory (RAM) or the like.

The following is a description of the functions of the recovery control unit 31a, the copy control unit 31b, and the rebuild control unit 31c that are realized by the CPU 31 in the present embodiment.

The functions realized in the present embodiment are as follows.

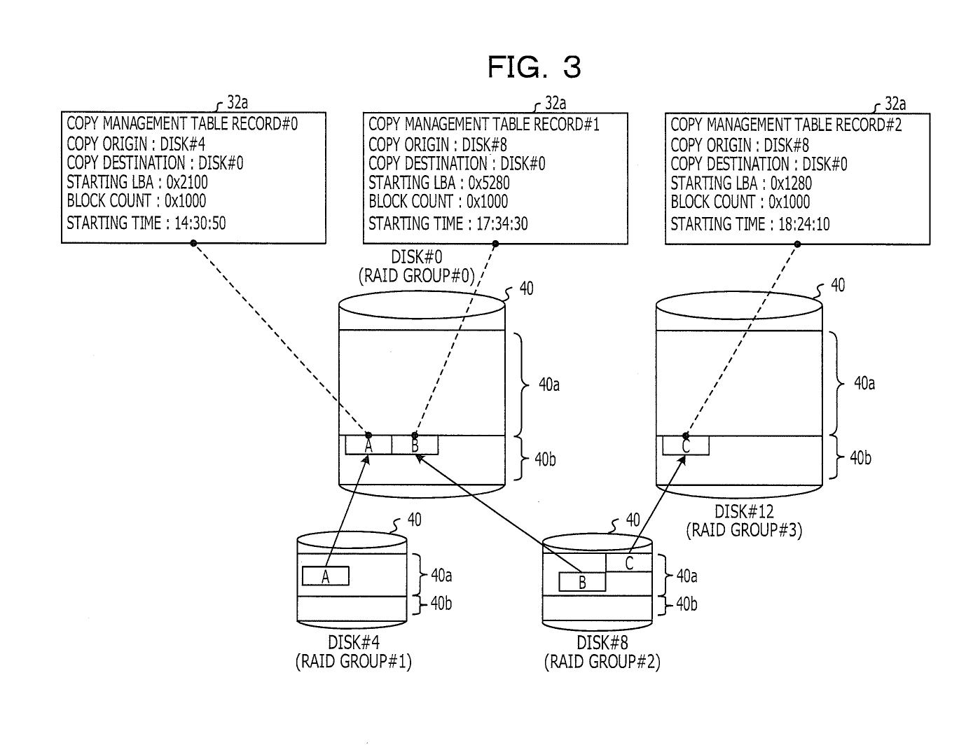

When a medium error region is detected with a certain access to a disk 40, the recovery control unit 31a conducts data recovery processing on the medium error region. The copy control unit 31b then copies data of the peripheral region including the medium error region from the disk 40 to a dedicated region 40b illustrated in FIG. 3 of another disk 40. As a result, redundancy of the data of the peripheral region may be improved. The data copied to the dedicated region in the other disk 40 is managed as described later in the copy management table 32a.

While the copy control unit 31b is conducting the copy processing to the dedicated region, if a medium error region is detected in the peripheral region subject to the copying, the recovery control unit 31a conducts data recovery processing on the detected medium error region.

When a failure in a disk 40 is detected, the rebuild control unit 31c uses data stored in the remaining disks 40 in the RAID group to which the failed disk 40 belongs, to reconstruct the data of the failed disk 40 in a substitute disk 40. At this time, if data stored in the remaining disks 40 is not read, the rebuild control unit 31c uses the copy management table 32a to read the associated data stored in the other disk 40.

In the following description, the disk 40 in which a medium error region is detected may be referred to as an error disk 40 or as a copy origin disk 40. The other disk 40 to which the data of the error disk 40 is copied by the copy control unit 31b may be referred to as a copy destination disk 40. The disk 40 in which a failure is detected may be referred to as a failed disk 40, and a remaining disk 40 (a disk 40 used in reconstructing the failed disk) in the RAID group to which the failed disk 40 belongs may be referred to as a rebuild origin disk 40. A substitute disk 40 (substitute memory device) in which the failed disk 40 is reconstructed may be referred to as a rebuild destination disk 40. Furthermore, the peripheral region may be referred to as a peripheral area and the dedicated region may be referred to as a dedicated area.

When a medium error region in which a medium error occurs is detected in a disk 40, the recovery control unit 31a conducts the data recovery processing on the medium error region. At this time, the recovery control unit 31a detects a region in which a certain access (for example, a disk read in the present embodiment) is failed in the disk 40 as the medium error region. A medium error is a physical defect as described above and a medium error region is a data block that includes the medium in which the medium error occurs.

At this time, the error disk 40 is one of the plurality of disks 40 (first memory devices) that belong to one RAID group 41. The recovery control unit 31a conducts the data recovery processing on the medium error region by using data stored in a disk 40 other than the error disk 40 among the plurality of disks 40 (first memory devices). As a result, the data in the medium error region is regenerated. The regenerated data is saved to a region (substitute region) without a defect in the error disk 40. The region without a defect is logically associated with the medium error region.

When a medium error region is detected in the disk 40, the copy control unit 31b copies, after the conduct of the data recovery processing on the medium error region, data of a peripheral region of the medium error region from the error disk 40 to a dedicated region 40b in another disk 40 illustrated in FIG. 3. The data stored in the peripheral region copied from the error disk 40 to another disk 40 includes data after the data recovery on the medium error region and data stored in an adjacent region physically connected to the medium error region.

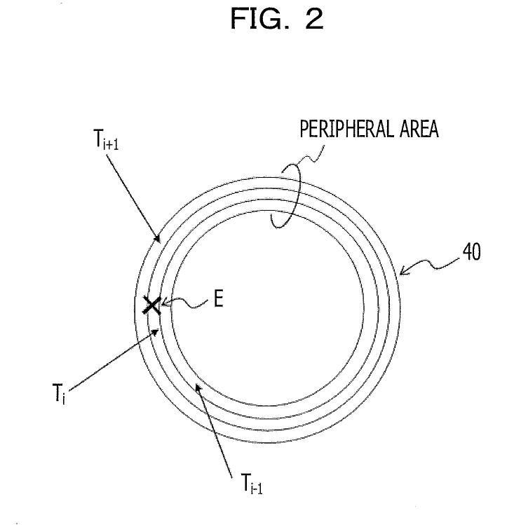

A detailed definition of the peripheral region (peripheral area) according to the present embodiment will be described with reference to FIG. 2. In the present embodiment, hard disk drives are used as the disks 40 and the peripheral area is an error track that includes a detected medium error region E and the adjacent tracks that are adjacent to the error track.

As illustrated in FIG. 2, for example, the peripheral area is represented as all sectors in three tracks from Tᵢ₋₁ to Tᵢ₊₁ that includes the error track Tᵢ (where i is a natural number) having the medium error region E, the track Tᵢ₋₁ on the inside of the track Tᵢ, and the track Tᵢ₊₁ on the outside of the track Tᵢ. The contents of the peripheral area may reach, for example, several megabytes (MB) when the peripheral area includes the all sectors in the three tracks Tᵢ₋₁ to Tᵢ₊₁.

The peripheral region is represented, in the present embodiment, as the error track, the track on the inside of the error track, and the track on the outside of the error track. However, the peripheral region is not limited to this and may also be represented as the error track, one or more tracks on the inside of the error track, and one or more tracks on the outside of the error track.

When a medium error region in the disk 40 is detected when a read access is conducted on data in a peripheral region during the copy processing by the copy control unit 31b for copying data of the peripheral region from the error disk 40 to another disk 40, the recovery control unit 31a also conducts the data recovery processing on the medium error region. At this time, if the detected location of the medium error region belongs to the track Tᵢ in FIG. 2, for example, the copy control unit 31b conducts the copy processing of the three tracks Tᵢ₋₁ to Tᵢ₊₁ as-is as the peripheral region (copy object).

If the detected location of the medium error region belongs to the track Tᵢ₋₁ in FIG. 2, for example, the copy control unit 31b adds the track Tᵢ₋₂ on the inside of the track Tᵢ₋₁ to the peripheral region and conducts the copy processing on the four tracks Tᵢ₋₂ to Tᵢ₊₁ as the copy object. Similarly, if the detected location of the medium error region belongs to the track Tᵢ₊₁ in FIG. 2, for example, the copy control unit 31b adds the track Tᵢ₊₂ on the outside of the track Tᵢ₊₁ to the peripheral region and conducts the copy processing on the four tracks Tᵢ₋₁ to Tᵢ₊₂ as the copy object.

Registration contents of the copy management table 32a and a method for using a dedicated region (dedicated area) according to the present embodiment will be described in detail with reference to FIG. 3.

As illustrated in FIG. 3, a user region (user area) 40a to be used by a user is secured and a region of several tens of megabytes is defined and secured as the dedicated area 40b of each of the disks 40 that configure the disk unit 4 of the present embodiment. The dedicated area 40b of each disk 40 is sharable among the plurality of RAID groups 41 (RAID group#0 to RAID group#k). As illustrated in FIG. 3, data stored in a peripheral region of a medium error region in which an error occurs in an error disk 40 is copied and saved by the copy control unit 31b to the dedicated areas 40b of the disks 40. Copy states in the dedicated areas 40b of the disks 40 are managed in the copy management table 32a stored in the memory 32.

In the example illustrated in FIG. 3, the data stored in the peripheral region of the medium error region in which the error occurs in the error disk 40 is preferentially copied and saved to the dedicated area 40b of a disk 40 that belongs to a RAID group 41 that differs from the RAID group 41 to which the error disk 40 belongs. More specifically, in FIG. 3, peripheral area data A stored in the user area 40a in the error disk#4 that belongs to the RAID group#1 is copied and saved by the copy control unit 31b to the dedicated area 40b of the copy destination disk#0 that belongs to the RAID group#0. In addition to the above copy processing, the copy control unit 31b registers and saves, for example, the below-mentioned information (a1) through (a5) to a record#0 of the copy management table 32a stored in the memory 32 as illustrated in FIG. 3.

(a1) Disk number (identification information) “disk#4” of the error disk 40 that is the copy origin disk.

(a2) Disk number “disk#0” of the copy destination disk 40.

(a3) Starting logical block address (LBA) “0x2100” of the peripheral area data A.

(a4) Block count “0x1000” of the peripheral area data A.

(a5) Starting time “14:30:50” of copying peripheral area data A by the copy control unit 31b.

Further, in FIG. 3, peripheral area data B stored in the user area 40a in the error disk#8 that belongs to the RAID group#2 is copied and saved by the copy control unit 31b to the dedicated area 40b of the copy destination disk#0 that belongs to the RAID group#0. In addition to the above copy processing, the copy control unit 31b registers and saves, for example, the below-mentioned information (b1) through (b5) to a record#1 of the copy management table 32a stored in the memory 32 as illustrated in FIG. 3.

(b1) Disk number “disk#8” of the error disk 40 that is the copy origin disk.

(b2) Disk number “disk#0” of the copy destination disk 40.

(b3) Starting LBA “0x5280” of peripheral area data B.

(b4) Block count “0x1000” of peripheral area data B.

(b5) starting time “17:34:30” of copying peripheral area data B by the copy control unit 31b.

Similarly, in FIG. 3, peripheral area data C stored in the user area 40a in the error disk#8 that belongs to the RAID group#2 is copied and saved by the copy control unit 31b to the dedicated area 40b of the copy destination disk#12 that belongs to the RAID group#3. In addition to the above copy processing, the copy control unit 31b registers and saves, for example, the below-mentioned information (c1) through (c5) to a record#2 of the copy management table 32a stored in the memory 32 as illustrated in FIG. 3.

(c1) Disk number “disk#8” of the error disk 40 that is the copy origin disk.

(c2) Disk number “disk#12” of the copy destination disk 40.

(c3) Starting LBA “0x1280” of peripheral area data C.

(c4) Block count “0x1000” of peripheral area data C.

(c5) starting time “18:24:10” of copying peripheral area data C by the copy control unit 31b.

The copy management table 32a in which the above-mentioned information has been registered is used during the copy processing (avoidance of copy overlap) of the peripheral region data by the copy control unit 31b and during the rebuild processing by the rebuild control unit 31c as described later.

If the copy control unit 31b copies data to a copy destination disk 40 that has no available region for copying the data in the dedicated areas 40b thereof, the copy control unit 31b refers to the record pertaining to the copy destination disk 40 of the copy management table 32a and operates as described below. Specifically, the copy control unit 31b refers to the “starting time” information in the records pertaining to the copy destination disk 40 and selects a data block with the oldest “starting time” information and overwrites the peripheral area data of the copy object in the selected data block.

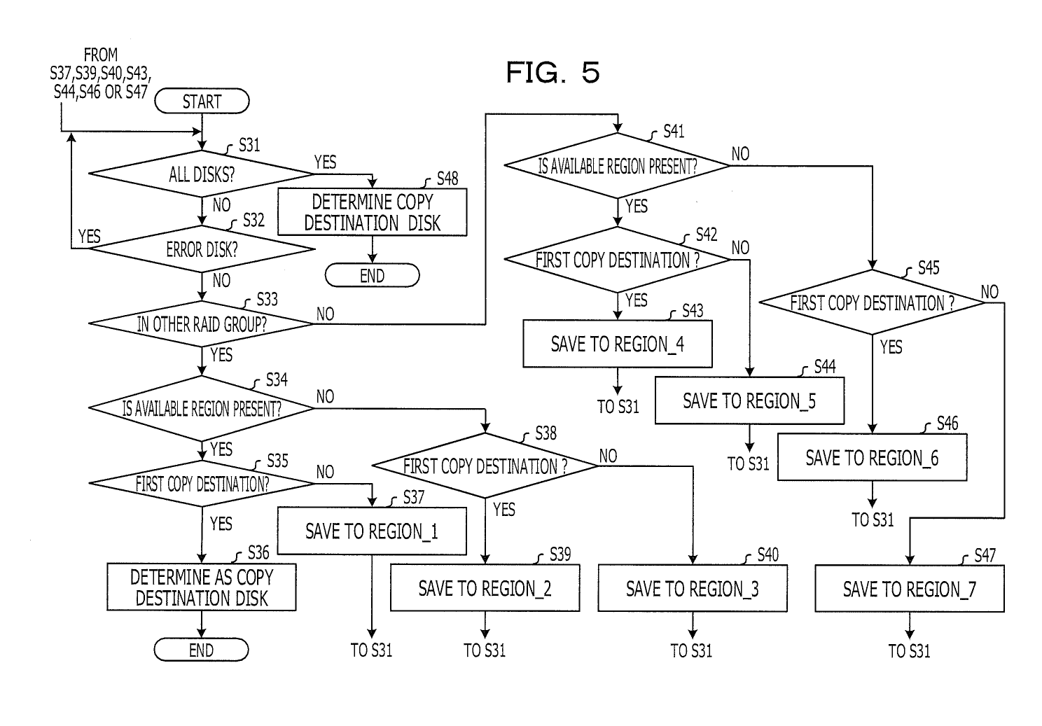

The copy control unit 31b selects candidates of the copy destination disk 40 (other disk) for copying the data in the peripheral area and determines the copy destination disk 40, from among the selected candidates, based on a combination of the following three decision criteria (d1) to (d3). A description of the determination processing by the copy control unit 31b to determine the copy destination disk 40 will be described later in detail with reference to FIG. 5.

(d1) Whether the disk 40 belongs to the RAID group 41 (own RAID group) including the error disk 40 in which the medium error is detected.

(d2) Whether there is an available region in the dedicated area 40b of the disk 40.

(d3) Whether the disk 40 is the first copy destination for the current error disk 40.

In accordance with the decision criteria (d1) to (d3), a disk 40 that is an unused disk or an HS (substitute disk) and is also the first copy destination for the current error disk 40 is determined preferentially as the copy destination disk 40 as described later with reference to FIG. 5 for example.

In particular, the copy control unit 31b of the present embodiment determines the copy destination disk 40 from among the disks 40 that belong to the own RAID group 41 and one or more disks 40 (second memory devices) that do not belong to the own RAID group 41 in accordance with certain rules and the copy management table 32a as described below.

Specifically, the copy control unit 31b determines which of the following first candidate (e1) to eighth candidate (e8) each of the disks 40 in the disk unit 4 matches.

If a disk 40 that matches the first candidate (e1) is found, the copy control unit 31b determines that the disk 40 that matches the first candidate (e1) is the copy destination disk 40 without making any judgments on the other disks 40.

Regions region_{—}1 to region_{—}7 to which identification information (disk IDs) for identifying the disks 40 of the second candidate (e2) to eighth candidate (e8) is saved as candidate disk information, are secured in the candidate disk information storage area 32b in the memory 32. When a disk 40 that matches any of the second candidate (e2) to eighth candidate (e8) is found, the copy control unit 31b writes and saves the identification information of the found disk 40 to the corresponding region of the candidate disk information storage area 32b. For example, when a disk 40 that matches the fifth candidate (e5) is found, the copy control unit 31b writes and saves the identification information of the found disk 40 to the region_{—}4. When the copy control unit 31b saves the identification information of the disk 40 to the candidate disk information storage area 32b, the copy control unit 31b does not save the current identification information if other identification information is already saved to the corresponding region.

If no disk 40 that matches the first candidate (e1) is found and the judgments for all the disks are completed, the copy control unit 31b refers to the region_{—}1 to region_{—}7 in the candidate disk information storage area 32b and determines one of the second candidate (e2) to eighth candidate (e8) to be the copy destination disk 40 in accordance with a certain priority sequence. For example, in the present embodiment, the priority sequence follows the order of the second candidate (e2) to the eighth candidate (e8), and if no disk 40 is found that matches the first candidate (e1), the copy control unit 31b determines the disk 40 (second candidate (e2)) identified by the identification information saved to the region_{—}1 to be the copy destination disk 40. If no identification information is saved to the region_{—}1, that is if no disk 40 that matches the second candidate (e2) is present, the copy control unit 31b determines the disk 40 (third candidate (e3)) identified by the identification information saved to the region_{—}2 to be the copy destination disk 40. Similarly, the copy control unit 31b determines any of the fourth candidate (e4) to eighth candidate (e8) to be the copy destination disk 40.

(e1) First candidate: disk 40 that does not belong to the RAID group 41 to which the error disk belongs, has an available dedicated area 40b, and is the first copy destination for the error disk.

(e2) Second candidate: disk 40 that does not belong to the RAID group 41 to which the error disk belongs, has an available dedicated area 40b, and is not the first copy destination for the error disk.

(e3) Third candidate: disk 40 that does not belong to the RAID group 41 to which the error disk belongs, does not have an available dedicated area 40b, and is the first copy destination for the error disk.

(e4) Fourth candidate: disk 40 that does not belong to the RAID group 41 to which the error disk belongs, does not have an available dedicated area 40b, and is not the first copy destination for the error disk.

(e5) Fifth candidate: disk 40 that belongs to the RAID group 41 to which the error disk belongs, has an available dedicated area 40b, and is the first copy destination for the error disk.

(e6) Sixth candidate: disk 40 that belongs to the RAID group 41 to which the error disk belongs, has an available dedicated area 40b, and is not the first copy destination for the error disk.

(e7) Seventh candidate: disk 40 that belongs to the RAID group 41 to which the error disk belongs, does not have an available dedicated area 40b, and is the first copy destination for the error disk.

(e8) Eighth candidate: disk 40 that belongs to the RAID group 41 to which the error disk belongs, does not have an available dedicated area 40b, and is not the first copy destination for the error disk.

If the copy control unit 31b determines one of the third candidate (e3), the fourth candidate (e4), the seventh candidate (e7), or the eighth candidate (e8) to be the copy destination disk 40, the copy control unit 31b refers to the “starting time” information in the copy management table 32a and overwrites the oldest data block in the dedicated area 40b of the copy destination disk 40 with the peripheral area data of the copy object.

When conducting the copy processing of the peripheral area data, the copy control unit 31b refers to the copy management table 32a to judge whether the range of the current copy object data overlaps the range of any one of copied data. If it is judged that there is no overlap, the copy control unit 31b determines the copy destination disk 40 from the above-mentioned first candidate (e1) to eighth candidate (e8) and copies the peripheral area data stored in the error disk 40 to the determined copy destination disk 40.

If it is judged that the range of the current copy object data partially overlaps the range of certain copied data, the copy control unit 31b does not determine the copy destination disk 40 from the above-mentioned first candidate (e1) to eighth candidate (e8), but determines the disk 40 in which the overlapping data is saved as the copy destination disk 40. The copy control unit 31b then copies the data of the range (non-overlap area) that does not overlap the copied data range within the range of the current copy object data, from the error disk 40 to the copy destination disk 40. As a result, copy overlap of the peripheral area data is avoided.

The copy control unit 31b updates the information (the starting LBA, the data block count, and the copy starting time) in the record of the copy management table 32a, which is the previously registered record for the overlapping data in the copy destination disk 40. At this time, the copy control unit 31b updates the starting LBA, the data block count, and the copy starting time when adding the data of the non-overlap area to the front of the overlapping data in the copy destination disk 40. The copy control unit 31b updates the data block count and the copy starting time when adding the data of the non-overlap area to the rear of the overlapping data in the copy destination disk 40.

When it is judged that the range of the current copy object data and the range of the copied data completely overlap each other, that is if it is judged that the ranges match each other, the copy control unit 31b may not conduct the copy processing and may only update the copy starting time of the record of the copy management table 32a pertaining to the disk 40 in which the overlapping data is saved.

When it is judged that the range of the current copy object data overlaps ranges of copied data in two different disks 40, the copy control unit 31b determines the disk 40 with a larger amount the range overlapping the current copy object data between the two different disks 40 to be the copy destination disk 40. The copy control unit 31b then conducts the copy processing and the update processing of the copy management table 32a in the same way as described above.

There is a possibility that the copy processing to the dedicated areas 40b of the disks 40 may increase the load on the storage control device 5 (RAID device). Accordingly, the copy control unit 31b is configured so as to conduct the copy processing of the peripheral area data at the following timings so that the copy processing is conducted as much as possible while reducing the load on the storage control device 5 or avoiding a reduction in processing performance of the storage control device 5. Specifically, the copy control unit 31b conducts the copy processing in a time zone time zone_{—}1 or time zone_{—}2. Time zone_{—}1 is a time zone in which the load on the storage system 1 including the disk unit 4 is light. Time zone_{—}2 is a time zone in which functions that are not held accountable for poor performance to some extent are being conducted in the storage system 1.

The nighttime or a weekend, for example, may be considered to be the time zone_{—}1 in which the load on the storage system 1 is light, and thus the copy control unit 31b schedules the copy processing to be conducted in time zone_{—}1.

When the copy processing is to be conducted in time zone_{—}2 in which functions that are not held accountable for poor performance to some extent are being conducted in the storage system 1, the copy control unit 31b performs scheduling so that the copy processing is coordinated with such functions. For example, copying functions or analysis functions may be considered as functions that are not held accountable for poor performance to some extent. In this case, the copy control unit 31b schedules disk read for copying the peripheral area data to the dedicated areas 40b to be conducted concurrently with disk read due to copying functions or analysis functions.

As described above, a rebuild is processing for automatically recovering redundancy in a RAID group 41. When a disk 40 that belongs to the RAID group 41 fails, the rebuild is conducted such that the data of the failed disk 40 is reconstructed to a substitute disk 40 (HS) by using data stored in a disk 40 other than the failed disk 40 in the same RAID group 41. A disk 40 is considered to have failed when, for example, a medium error has occurred a certain number of times.

The rebuild control unit 31c controls the conduct of the rebuild processing as described above when a failure in a disk 40 is detected (when a failed disk 40 is detected). Specifically, when a failed disk is detected, the rebuild control unit 31c reconstructs the data of the failed disk 40 in a substitute disk 40 (rebuild destination disk) substitute for the failed disk 40 by using data of the rebuild origin disk 40. The rebuild origin disk 40 is a disk 40 other than the failed disk 40 in the RAID group 41 to which the failed disk 40 belongs.

If the rebuild control unit 31c is not able to read a data block to be reconstructed from the rebuild origin disk 40 to the substitute disk 40 (rebuild destination disk), that is if a medium error occurs in the rebuild origin disk 40, the rebuild control unit 31c judges whether a record that includes information pertaining to the data block has been registered in the copy management table 32a.

If a record that includes the information pertaining to the data block has been registered in the copy management table 32a, the rebuild control unit 31c reads the data block from the disk 40 (other memory device) having the dedicated area 40b to which the data block is saved, based on the information pertaining to the data block. Specifically, the rebuild control unit 31c treats the disk 40 having the dedicated area 40b to which the data block is saved, as the rebuild origin disk 40 and conducts disk read of the data block. If the data block is read from the rebuild origin disk 40, the rebuild control unit 31c reconstructs the data of the failed disk 40 by writing the read data block into the substitute disk 40.

In this way, when a medium error occurs in a peripheral area of the initial medium error (the medium error that occurs first) during the rebuild, the data in the dedicated area 40b is used based on the copy management table 32a and the recovery processing for the medium error is conducted.

If a record including the information pertaining to the data block is not registered in the copy management table 32a, or if the data block is not able to be read from the rebuild origin disk 40, the rebuild control unit 31c determines that data loss has occurred and sends a notification to the user, for example.

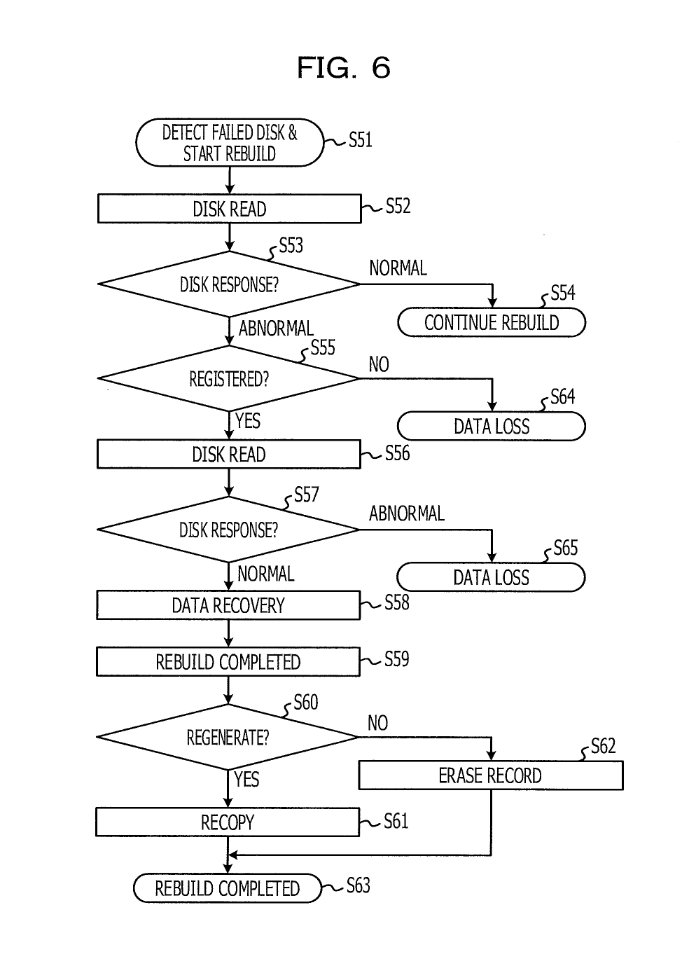

A description of the above-mentioned rebuild processing by the rebuild control unit 31c will be described in detail with reference to FIG. 6.

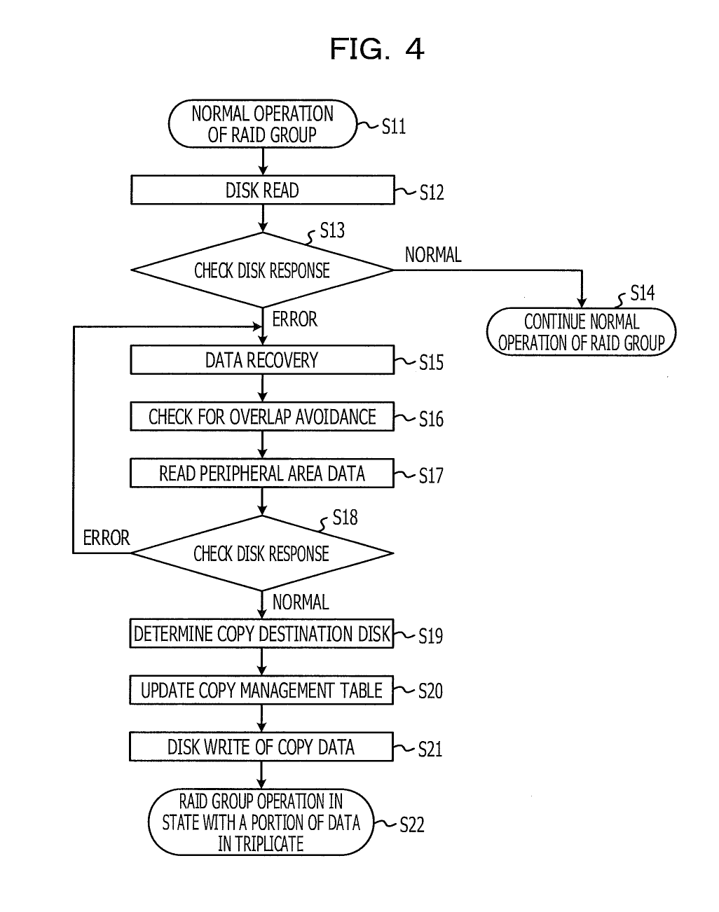

The following is a description of operations by the storage system 1 and the storage control device 5 of the present embodiment configured as described above with reference to FIGS. 4 to 6.

First, recovery processing by the recovery control unit 31a and copy processing by the copy control unit 31b according to the present embodiment will be described with reference to a flow chart (S11 to S22) illustrated in FIG. 4.

During normal operation of a RAID group 41 (S11), a disk read is conducted (S12) and a response from the disk 40 regarding the disk read is checked (S13). If the response from the disk 40 is normal, that is if the data is read properly from the disk 40 (S13: “Normal”), the normal operation of the RAID group 41 is continued (S14).

If the response from the disk 40 is not normal, that is if the data is not read properly from the disk 40 and a medium error occurs (S13: “Error”), data recovery processing that involves medium recovery is conducted (S15). At this time, the data recovery processing on the medium error region is conducted by the recovery control unit 31a using data of a disk 40 other than the error disk 40 in the RAID group 41. As a result, the data in the medium error region is regenerated.

Next, the copy control unit 31b refers to the copy management table 32a and conducts the above-mentioned check for avoiding overlap of copying data to the dedicated area 40b (S16). Specifically, the copy control unit 31b checks whether the peripheral area (range of current copy object data) of the medium error region regenerated in S15 overlaps a range of copied data in the dedicated area 40b. The copy control unit 31b uses the result of the check for copy overlap in S16 in the determination processing of the copy destination disk 40 in S19 and in the disk write processing (copy processing) of the copy data in S22.

Reading (disk read) of the data in the peripheral area that is the copy object is conducted by the copy control unit 31b to copy the data in the peripheral area of the medium error region from the error disk 40 to the dedicated area 40b of the other disk 40 (S17). When the disk read is conducted, the response from the disk 40 regarding the disk read is checked (S18) in the same way as in S13. If the response from the disk 40 is normal, that is if the data is read properly from the disk 40 (S18: “Normal”), the copy control unit 31b proceeds to the processing in S19.

If the response from the disk 40 is not normal, that is if the data is not read properly from the disk 40 and a medium error occurs (S18: “Error”), the processing from S15 to S18 is conducted again.

When the data in the peripheral area of the medium error region is read properly from the disk 40 (S18: “Normal”), the copy destination disk is determined by the copy control unit 31b (S19).

If the result of the check in S16 indicates that there is no overlap, the copy destination disk 40 is determined by the copy control unit 31b in S19 from the above-mentioned first candidate (e1) to eighth candidate (e8) in accordance with the sequence described later with reference to FIG. 5. If the result of the check in S16 indicates that there is an overlap (partial overlap), the copy control unit 31b determines the disk 40 having the data overlapping the peripheral area data saved therein to be the copy destination disk 40 as described above.

The copy control unit 31b then creates or updates the associated record of the copy management table 32a stored in the memory 32 in accordance with the contents of the copy processing conducted at this time (S20).

A new record is created in the copy management table 32a in S20 if no record associated with the peripheral area to be copied at this time has been registered in the copy management table 32a (that is, the result of the check in S16 indicates that there is no overlap). Information the same as the above-mentioned information (a1) to (a5), (b1) to (b5), or (c1) to (c5), that is the following information (f1) to (f5) pertaining to the current copy processing, is registered in the created record. If a record associated with the peripheral area data currently to be copied has been registered in the copy management table 32a (that is if the result of the check in S16 indicates that there is an overlap), the following information (f3) to (f5) or the following information (f4) and (f5) is updated as described above.

(f1) Disk number of the error disk 40 that is the copy origin disk.

(f2) Disk number of the copy destination disk 40.

(f3) Starting LBA of the peripheral area data of the copy object.

(f4) Block count of the peripheral area data of the copy object.

(f5) starting time of copying peripheral area data by the copy control unit 31b.

When the record is created or updated in the copy management table 32a, the copy control unit 31b writes (disk write) and saves the peripheral area data (copy data) read from the error disk 40 in S17 to the dedicated area 40b of the copy destination disk 40 determined in S19 (S21).

If the result of the check in S16 indicates that there is no overlap, all of the read peripheral area data is copied in S21 to the dedicated area 40b of the copy destination disk 40 determined from among the first candidate (e1) to the eighth candidate (e8) in S19. If the result of the check in S16 indicates that there is an overlap (partial overlap), the copying range is adjusted. Specifically, among the read peripheral area data, the data in the range (non-overlap area) that does not overlap the range of the copied data is copied to the dedicated area 40b of the disk 40 having the overlapping data saved therein. As a result, copy overlap of the peripheral area data is avoided.

According to the above processing, redundancy is improved for the peripheral area data of the medium error region in which the medium error has occurred. In particular, after the copy processing in the present embodiment, the peripheral area data enters a triplicated state instead of a duplicated state (S22).

While the copy control unit 31b conducts the processing in S21 after conducting the processing in S20 in the flow chart illustrated in FIG. 4, the copy control unit 31b may also conduct the processing in S20 after the processing in S21.

Processing for determining the copy destination disk 40 by the copy control unit 31b according to the present embodiment will be described with reference to a flow chart (S31 to S48) illustrated in FIG. 5. In particular, processing to determine the copy destination disk 40 in a case where the result of the check in S16 indicates that there is no overlap will be described. In this case, all of the disks 40 in the disk unit 4 are judged to match which of the first candidate (e1) to the eighth candidate (e8), and the copy destination disk 40 is determined from among the first candidate (e1) to the eighth candidate (e8).

First, the copy control unit 31b judges whether the processing on all the disks 40 in the disk unit 4 is completed or not (S31). If the processing on all the disks 40 has been completed (S31: YES), the copy control unit 31b proceeds to the below-mentioned processing in S48.

If the determination processing on all the disks 40 has not been completed (S31: NO), the copy control unit 31b judges whether the disk 40 subject to the current processing is an error disk that includes a medium error region (S32). Whether the currently processed disk 40 is an error disk may be determined, for example, by determining whether the disk number (identification information) of the currently processed disk 40 has been registered as the information (f1) in the copy management table 32a. The currently processed disk 40 is determined as an error disk if the disk number (identification information) of the currently processed disk 40 has been registered as the information (f1) in the copy management table 32a.

If the currently processed disk 40 is an error disk (S32: YES), the copy control unit 31b does not make the currently processed disk 40 a copy destination disk 40 and the processing returns to S31. If the currently processed disk 40 is not an error disk (S32: NO), the copy control unit 31b conducts the processing from S33 to S47 as described below.

Specifically, if the currently processed disk 40 is not an error disk (S32: NO), the copy control unit 31b judges whether the currently processed disk 40 is a disk in a RAID group 41 other than the RAID group 41 (own RAID group) to which the error disk belongs (S33). If the currently processed disk 40 is a disk included in a RAID group 41 other than the own RAID group 41 (S33: YES), the copy control unit 31b judges whether there is an available region in the dedicated area 40b of the currently processed disk 40 based on the information in the copy management table 32a (S34).

If an available region is present in the dedicated area 40b of the currently processed disk 40 (S34: YES), the copy control unit 31b judges whether the currently processed disk 40 is the first copy destination for the current error disk based on the information in the copy management table 32a (S35).

If the currently processed disk 40 is the first copy destination for the current error disk (S35: YES), the currently processed disk 40 matches the first candidate (e1) and the copy control unit 31b determines that currently processed disk 40 is the copy destination disk 40 (S36), and the processing is finished.

If a disk 40 that matches the first candidate (e1) is found in this way, the copy control unit 31b determines that the disk 40 that matches the first candidate (e1) is the copy destination disk 40 without making any subsequent judgments on the other disks 40. As a result, the disk 40 that is an unused disk or an HS (substitute disk) that does not belong to the own RAID group 41 and that is the first copy destination for the current error disk, is preferentially determined as the copy destination disk 40.

If the currently processed disk 40 is not the first copy destination for the current error disk (S35: NO), the copy control unit 31b judges that the currently processed disk 40 matches the second candidate (e2). The copy control unit 31b then saves the identification information (disk ID, etc.) of the currently processed disk 40 as candidate disk information to the region_{—}1 in the candidate disk information storage area 32b of the memory 32 (S37), and the processing returns to S31. If any identification information has been previously saved to the region_{—}1, the identification information of the currently processed disk 40 is not saved.

If no available region is present in the dedicated area 40b of the currently processed disk 40 (S34: NO), the copy control unit 31b judges whether the currently processed disk 40 is the first copy destination for the current error disk based on the information in the copy management table 32a (S38).

If the currently processed disk 40 is the first copy destination for the current error disk (S38: YES), the copy control unit 31b judges that the currently processed disk 40 matches the third candidate (e3). The copy control unit 31b then saves the identification information (disk ID, etc.) of the currently processed disk 40 as candidate disk information to the region_{—}2 in the candidate disk information storage area 32b of the memory 32 (S39), and the processing returns to S31. If any identification information has been previously saved to the region_{—}2, the identification information of the currently processed disk 40 is not saved.

If the currently processed disk 40 is not the first copy destination for the current error disk (S38: NO), the copy control unit 31b judges that the currently processed disk 40 matches the fourth candidate (e4). The copy control unit 31b then saves the identification information (disk ID, etc.) of the currently processed disk 40 as candidate disk information to the region_{—}3 in the candidate disk information storage area 32b of the memory 32 (S40), and the processing returns to S31. If any identification information has been previously saved to the region_{—}3, the identification information of the currently processed disk 40 is not saved.

If the currently processed disk 40 is not a disk from a RAID group 41 other than the own RAID group 41 (S33: NO), the copy control unit 31b judges whether there is an available region in the dedicated area 40b of the currently processed disk 40 based on the information in the copy management table 32a (S41).

If an available region is present in the dedicated area 40b of the currently processed disk 40 (S41: YES), the copy control unit 31b judges whether the currently processed disk 40 is the first copy destination for the current error disk based on the information in the copy management table 32a (S42).

If the currently processed disk 40 is the first copy destination for the current error disk (S42: YES), the copy control unit 31b judges that the currently processed disk 40 matches the fifth candidate (e5). The copy control unit 31b then saves the identification information (disk ID, etc.) of the currently processed disk 40 as candidate disk information to the region_{—}4 in the candidate disk information storage area 32b of the memory 32 (S43), and the processing returns to S31. If any identification information has been previously saved to the region_{—}4, the identification information of the currently processed disk 40 is not saved.

If the currently processed disk 40 is not the first copy destination for the current error disk (S42: NO), the copy control unit 31b judges that the currently processed disk 40 matches the sixth candidate (e6). The copy control unit 31b then saves the identification information (disk ID, etc.) of the currently processed disk 40 as candidate disk information to the region_{—}5 in the candidate disk information storage area 32b of the memory 32 (S44), and the processing returns to S31. If any identification information has been previously saved to the region_{—}5, the identification information of the currently processed disk 40 is not saved.

If no available region is present in the dedicated area 40b of the currently processed disk 40 (S41: NO), the copy control unit 31b judges whether the currently processed disk 40 is the first copy destination for the current error disk based on the information in the copy management table 32a (S45).

If the currently processed disk 40 is the first copy destination for the current error disk (S45: YES), the copy control unit 31b judges that the currently processed disk 40 matches the seventh candidate (e7). The copy control unit 31b then saves the identification information (disk ID, etc.) of the currently processed disk 40 as candidate disk information to the region_{—}6 in the candidate disk information storage area 32b of the memory 32 (S46), and the processing returns to S31. If any identification information has been previously saved to the region_{—}6, the identification information of the currently processed disk 40 is not saved.

If the currently processed disk 40 is not the first copy destination for the current error disk (S45: NO), the copy control unit 31b judges that the currently processed disk 40 matches the eighth candidate (e8). The copy control unit 31b then saves the identification information (disk ID, etc.) of the currently processed disk 40 as candidate disk information to the region_{—}7 in the candidate disk information storage area 32b of the memory 32 (S47), and the processing returns to S31. If the identification information has been previously saved to the region_{—}7, the identification information of the currently processed disk 40 is not saved.

If no disk 40 that matches the first candidate (e1) is found and the processing on all the disks 40 is completed based on the above processing (S31: YES), the copy control unit 31b proceeds to the processing in S48. At this time, the identification information of the disks 40 judged to match any of the second candidate (e2) to the eighth candidate (e8) based on the processing in S31 to S47 is saved in the respective regions region_{—}1 to region_{—}7 in the candidate disk information storage area 32b.

In S48, the copy control unit 31b refers to the regions region_{—}1 to region_{—}7 in the candidate disk information storage area 32b to determine the copy destination disk 40 in the order of the regions region_{—}1 to region_7 (second candidate (e2) to eighth candidate (e8)).

As described above, a disk 40 that does not belong to the own RAID group is preferentially determined as the copy destination disk 40 over a disk 40 that does belong to the own RAID group. Further, a disk 40 having an available region in the dedicated area 40b is preferentially determined as the copy destination disk 40 over a disk 40 that does not have an available region in the dedicated area 40b. Furthermore, a disk 40 that is the first copy destination for the error disk is preferentially determined as the copy destination disk 40 over a disk 40 that is not the first copy destination for the error disk.

As a result, a disk 40 that is considered to be secure with respect to the error disk is preferentially determined as the copy destination disk 40. Therefore, the peripheral area data of the medium error region is saved in a disk 40 that is considered to be secure with respect to the error disk and thus the peripheral area data is saved securely and redundancy of the peripheral area data is assured.

The copy starting time in the copy management table 32a is referred to if one of the third candidate (e3), the fourth candidate (e4), the seventh candidate (e7), or the eight candidate (e8) is determined as the copy destination disk 40. The oldest data block in the dedicated area 40b of the copy destination disk 40 is then selected and the peripheral area data of the copy object is used to overwrite the selected oldest data block.

A rebuild processing by the rebuild control unit 31c according to the present embodiment will be described with reference to a flow chart (S51 to S65) illustrated in FIG. 6.

When a failed disk 40 is detected, the rebuild processing is started in which the rebuild control unit 31c reconstructs the data of the failed disk 40 in a substitute disk 40 (rebuild destination disk) substitute for the failed disk 40 by using data of the rebuild origin disk 40 (S51).

When the rebuild processing is initiated, disk read on the rebuild origin disk 40 is conducted and data blocks are sequentially read from the rebuild origin disk 40 to the HS 40 (rebuild destination disk, substitute disk) (S52). Each time the disk read is conducted, the response from the rebuild origin disk 40 subject to the disk read is checked (S53).

If the response from the rebuild origin disk 40 is normal, that is if the data block from the rebuild origin disk 40 is read properly (S53: “Normal”), the rebuild processing is continued (S54).

If the response from the rebuild origin disk 40 is not normal, that is if a medium error occurs in the rebuild origin disk 40 (S53: “Abnormal”), the rebuild control unit 31c refers to the copy management table 32a. The rebuild control unit 31c then checks whether a record including information pertaining to the data block accessed in S52 has been registered in the copy management table 32a (S55).

If no record pertaining to the data block has been registered in the copy management table 32a (S55: NO), the rebuild control unit 31c judges that a data loss has occurred (S64) and sends a notification to the user, for example.

If a record pertaining to the data block has been registered in the copy management table 32a (S55: YES), the rebuild control unit 31c determines the disk 40 having the dedicated area 40b to which the data block is saved as the rebuild origin disk 40 based on the information pertaining to the data block, which has been registered in the copy management table 32a. The rebuild control unit 31c then conducts disk read on the rebuild origin disk 40 to which the data block is saved and reads the data block from the rebuild origin disk 40 (dedicated area 40b) to the rebuild destination disk 40 (S56).

The response from the rebuild origin disk 40 subject to the disk read is checked (S57). If the response from the rebuild origin disk 40 is not normal, that is if a medium error occurs in the rebuild origin disk 40 (S57: “Abnormal”), the rebuild control unit 31c judges that a data loss has occurred (S65) and sends a notification to the user, for example.

If the response from the rebuild origin disk 40 is normal, that is if the data block is read properly from the rebuild origin disk 40 (S57: “Normal”), the rebuild control unit 31c recovers the data of the failed disk 40 in the rebuild destination disk 40 by writing the read data block into the rebuild destination disk 40 (S58). In this way, when a medium error occurs in a peripheral area of the initial medium error (the medium error that has occurred first) during the rebuild, the data in the dedicated area 40b is used based on the copy management table 32a and the recovery processing for the medium error is conducted.

The rebuild processing is continued in the same way as described above and when the rebuild processing of the user area 40a (see FIG. 3) in the failed disk 40 is completed (S59), the rebuild control unit 31c judges whether to conduct the regeneration of the dedicated area 40b of the failed disk 40 (S60). The judgment is conducted in accordance with an instruction from the user (user of the RAID device). Whether the regeneration of the dedicated area 40b is conducted or not is set beforehand by the user.

If the regeneration of the dedicated area 40b is to be conducted (S60: YES), the rebuild control unit 31c extracts a record in which the failed disk 40 has been registered as the copy destination from the copy management table 32a. The rebuild control unit 31c then recopies the data block of the range specified in the extracted record to the dedicated area 40b of the rebuild destination disk 40, updates the copy management table 32a in accordance with the copying (S61), and the rebuild processing is completed (S63).

If the regeneration of the dedicated area 40b is not to be conducted (S60: NO), the rebuild control unit 31c extracts records in which the failed disk 40 has been registered as the copy destination from the copy management table 32a. The rebuild control unit 31c then erases the extracted record from the copy management table 32a (S62) and the rebuild processing is completed (S63).

When a medium error is detected during the disk read, the storage system 1 and the storage control device 5 according to the present embodiment copy data in the peripheral area of the medium error region. As a result, redundancy is improved for the peripheral area data of the medium error region in which the medium error has occurred, preemptive data construction is realized for an abnormal region inside a disk in the storage device 3, and the data in the peripheral area of the medium error region in the disk 40 is assured.

By copying the data in the peripheral area of the medium error region, a medium error in a peripheral area may be quickly detected and recovered.

The copying of the peripheral area data is managed by using the copy management table 32a. Consequently, when a medium error occurs in a peripheral area of the initial medium error during a rebuild of the failed disk 40, the data in the dedicated area 40b is used based on the copy management table 32a and the recovery processing for the medium error is conducted. As a result, the occurrence of data loss may be suppressed.

The presence of overlapping is checked between a range of data to be copied to the dedicated area 40b and a range of data previously copied in the dedicated area 40b by using the copy management table 32a. When the result of the check indicates that overlap (partial overlap) is present, the data of the range (non-overlap area) that does not overlap the previously copied data is copied to the dedicated area 40b. As a result, copy overlap of the peripheral area data is avoided and the dedicated area 40b may be used more effectively.

A disk 40 that is an unused disk or an HS (substitute disk) that does not belong to the own RAID group 41 and that is the first copy destination for the current error disk is preferentially determined as the copy destination disk 40 in the present embodiment. Moreover, a disk 40 that is considered to be secure with respect to the error disk is preferentially determined as the copy destination disk 40. Therefore, the peripheral area data of the medium error region is saved to the disk 40 that is considered to be secure with respect to the error disk, and the peripheral area data is securely saved and redundancy of the peripheral area data is assured.

The copy processing to the dedicated areas 40b of the disks 40 is conducted during time zone_{—}1 in which the load on the storage system 1 is light, or during time zone_{—}2 in which functions that are not held accountable for poor performance to some extent are being conducted in the storage system 1. As a result, the copy processing is conducted as much as possible without increasing the load on the storage control device 5 or without inviting a reduction in processing performance.

While the embodiment has been described above, the present disclosure is not limited to the above-described embodiment and various improvements and modifications are possible without departing from the spirit of the disclosure.

All of or some of the functions of the above-mentioned recovery control unit 31a, the copy control unit 31b, and the rebuild control unit 31c may be realized by a computer (including a CPU, an information processor apparatus, and various types of terminals) executing a certain application program (storage control program).

The application program may be provided in a state of being recorded on a computer-readable storage medium such as, for example, a flexible disk, a compact disc (CD, CD-ROM, CD-R, CD-RW, etc.), a digital versatile disc (DVD, DVD-ROM, DVD-RAM, DVD-R, DVD-RW, DVD+R, DVD+RW, etc.), and/or a blu-ray disc and the like. In this case, the computer reads the program from the recording medium and uses the program by transferring and storing the program into an internal storage device or an external storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a processor configured to
detect medium error regions in a first memory device, a medium error occurring in each of the medium error regions,
conduct, on a first medium error region, data recovery processing for recovering data stored therein, and
conduct copy processing for copying first data of a peripheral region of the first medium error region from the first memory device to a second memory device other than the first memory device.

2. The storage control device according to claim 1, wherein
the processor is further configured to
conduct the data recovery processing on a second medium error region detected in the first memory device during the copy processing.

3. The storage control device according to claim 1, wherein
the first data includes
data of the first medium error region after the data recovery processing and
data stored in an adjacent region physically connected to the first medium error region.

4. The storage control device according to claim 1, wherein
the first memory device is a hard disk drive, and
the peripheral region includes an error track and a track adjacent to the error track, the error track including the first medium error region.

5. The storage control device according to claim 1, wherein
the processor is configured to
determine, as the medium error regions, regions to which the processor has failed to access.

6. The storage control device according to claim 1, wherein
the processor is further configured to
manage a copy management table for managing copy information on previously conducted copy processing, the copy information including
identification information of a previous first memory device,
identification information of a previous second memory device,
range information indicating a range of a previous peripheral region, and
a starting time of the previously conducted copy processing, and
conduct current copy processing with reference to the copy management table.

7. The storage control device according to claim 6, wherein
the processor is configured to
judge, with reference to the copy management table, whether a current peripheral region overlaps the previous peripheral region, and
copy, in the current copy processing, data of the current peripheral region within a range that does not overlap the previous peripheral region.

8. The storage control device according to claim 6, wherein
the first memory device is one of a plurality of primary memory devices that belong to a redundant array of inexpensive disks (RAID) group, and
the processor is configured to
conduct the data recovery processing on the first medium error region by using data stored in a third memory device other than the first memory device, the third memory device being one of the plurality of primary memory devices.

9. The storage control device according to claim 8, wherein
the processor is configured to
determine the second memory device from among the plurality of primary memory devices and one or more secondary memory devices not belonging to the RAID group.

10. The storage control device according to claim 9, wherein
each of the plurality of primary memory devices and the one or more secondary memory devices has dedicated regions to which the first data is copied, and
the processor is configured to
determine a first candidate device from among the one or more secondary memory devices, the first candidate device having an available dedicated region, the first candidate device being a first copy destination for the first memory device,
determine a second candidate device from among the one or more secondary memory devices, the second candidate device having an available dedicated region, the second candidate device not being the first copy destination for the first memory device,
determine a third candidate device from among the one or more secondary memory devices, the third candidate device not having an available dedicated region, the third candidate device being the first copy destination for the first memory device,
determine a fourth candidate device from among the one or more secondary memory devices, the fourth candidate device not having an available dedicated region, the fourth candidate device not being the first copy destination for the first memory device,
determine a fifth candidate device from among the plurality of primary memory devices, the fifth candidate device having an available dedicated region, the fifth candidate device being the first copy destination for the first memory device,
determine a sixth candidate device from among the plurality of primary memory devices, the sixth candidate device having an available dedicated region, the sixth candidate device not being the first copy destination for the first memory device,
determine a seventh candidate device from among the plurality of primary memory devices, the seventh candidate device not having an available dedicated region, the seventh candidate device being the first copy destination for the first memory device,
determine an eighth candidate device from among the plurality of primary memory devices, the eighth candidate device not having an available dedicated region, the eighth candidate device not being the first copy destination for the first memory device, and
determine the second memory device from among the first to eighth candidate devices in accordance with a predetermined priority sequence.

11. The storage control device according to claim 10, wherein
the processor is configured to
overwrite oldest data in a dedicated region of the second memory device with data of a current peripheral region with reference to the starting time in the copy management table when the second memory device is one of the third candidate device, the fourth candidate device, the seventh candidate device, and the eighth candidate device.

12. The storage control device according to claim 8, wherein
the processor is configured to
reconstruct, when a failure in the first memory device is detected, data stored in the first memory device by using data stored in the plurality of primary memory devices, in a substitute memory device substitute for the first memory device.

13. The storage control device according to claim 12, wherein
the processor is configured to
judge, when the processor has failed to read a data block to be reconstructed in the substitute memory device from the plurality of primary memory devices, whether first copy information pertaining to the data block has been registered in the copy management table, and
read, if the first copy information has been registered in the copy management table, the data block from the second memory device with reference to the first copy information.

14. The storage control device according to claim 13, wherein
the processor is configured to
reconstruct the data stored in the first memory device by writing the data block read from the second memory device in the substitute memory device.

15. The storage control device according to claim 1, wherein
the processor is configured to
conduct the copy processing in a first time zone or in a second time zone, a load on a system that includes the first memory device being light in the first time zone, functions that are not held accountable for poor performance being conducted in the second time zone.

16. A storage control method, comprising:
detecting, by a storage control device, medium error regions in a first memory device, a medium error occurring in each of the medium error regions,
conducting, on a first medium error region, data recovery processing for recovering data stored therein, and
conducting copy processing for copying first data of a peripheral region of the first medium error region from the first memory device to a second memory device other than the first memory device.

17. The storage control method according to claim 16, further comprising:
conducting the data recovery processing on a second medium error region detected in the first memory device during the copy processing.

18. The storage control method according to claim 16, wherein
the first data includes
data of the first medium error region after the data recovery processing and
data stored in an adjacent region physically connected to the first medium error region.

19. The storage control method according to claim 16, wherein
the first memory device is a hard disk drive; and
the peripheral region includes an error track and a track adjacent to the error track, the error track including the first medium error region.

20. A computer-readable recording medium having stored therein a program for causing a computer to execute a process, the process comprising:
detecting medium error regions in a first memory device, a medium error occurring in each of the medium error regions,
conducting, on a first medium error region, data recovery processing for recovering data stored therein, and
conducting copy processing for copying first data of a peripheral region of the first medium error region from the first memory device to a second memory device other than the first memory device.
